(19) United States
(12) Patent Application Publication
(10) Pub. No.: US 2017/0017765 A1
(43) Pub. Date: Jan. 19, 2017

(54) PROVIDER DRIVEN MODEL REMOTE HEALTHCARE MONITORING BILLING SYSTEM

(71) Applicant: 1COMM MEDICAL, INC., Ankeny, IA (US)

(72) Inventors: Scott D. Yegge, Ankeny, IA (US); Teresa A. Sieck, Ankeny, IA (US); Lucas A. Bland, Ankeny, IA (US); Scott A. Wallace, Ankeny, IA (US)

(21) Appl. No.: 15/282,470

(22) Filed: Sep. 30, 2016

Related U.S. Application Data
(63) Continuation-in-part of application No. 14/504,662, filed on Oct. 2, 2014.

(51) Int. Cl. G06F 19/00; G06Q 20/02

(52) U.S. Cl. CPC G06F 19/3406; G06F 19/328; G06Q 20/023

(57) ABSTRACT

A healthcare monitoring and billing system having a practice management system connected to a third party facilitator system. A remote testing device is assigned to a patient that automatically transmits test results upon completion. Once reviewed by a healthcare provider a claim and billing request are automatically sent to a healthcare clearing house.

### CROSS REFERENCE TO RELATED APPLICATION

This application is a continuation-in-part of U.S. patent application Ser. No. 14/504,662 filed on Oct. 2, 2014 which claims the benefit of U.S. Provisional Application No. 61/885,732 filed Oct. 2, 2013.

### BACKGROUND OF THE INVENTION

This invention is directed to a remote healthcare monitoring system, and more particularly a remote healthcare monitoring system that provides greater incentive for healthcare provider use.

Remote healthcare monitoring is known in the art. While known, current systems require outside testing companies and lack Patient-Provider accountability. Due to an inefficient model of care and delivery and a disconnect between the patient and provider, new remote monitoring systems are lended opportunity. Despite proven benefits for home monitoring, providers to date have been reserved with the current offerings. The new proposed provider driven model of delivery and management contains costs, encourages accountability, and improves quality. Due to the limited enrollment in home monitoring there exists a need in the art for a remote healthcare monitoring system that addresses these deficiencies and targets the provider and patient in a joint driving force. The provider and patient are engaged in an accountable fashion when the PROVIDER DRIVEN MODEL of delivery and management are implemented.

Thus, an objective of the present invention is to provide a remote healthcare monitoring system that improves upon the state of the art.

Another object of the present invention is to provide a remote healthcare monitoring system that is easier to use by healthcare providers and patients.

Yet another object of the present invention is to provide a remote healthcare monitoring system that offers more efficient enrollment, data transfer and tracking system.

Another object of the present invention is to provide a remote healthcare monitoring system that contains costs.

Yet another object of the present invention is to provide a remote healthcare monitoring system that automates billing.

Another object of the present invention is to provide a remote healthcare monitoring system that engages the patient and provider to strengthen accountability.

A further objective of the present invention is to provide a remote healthcare monitoring system that creates tracking of clinical and financial outcomes for a healthcare provider or healthcare system.

These and countless other objects, features, advantages, benefits and improvements will become apparent from the specification, drawings and claims.

### BRIEF SUMMARY OF THE INVENTION

A provider driven model remote healthcare monitoring and billing system has a practice management system operated by a health care provider that is connected via an electronic network to a third party facilitator system. The health care provider assigns a remote testing device to a patient with predetermined testing protocols. Upon completion of a test, results are automatically transmitted to the third party facilitator system and/or the practice management system.

Once the test results have been reviewed by the healthcare provider the third party facilitator system determines in billing guidelines have been met and automatically sends a claim request and a billing claim to a healthcare clearing house. The health care clearing house processes the requests and transfers payment to the healthcare provider.

### BRIEF DESCRIPTION OF THE DRAWINGS

FIG. 1 is a schematic view of a healthcare monitoring and billing system;

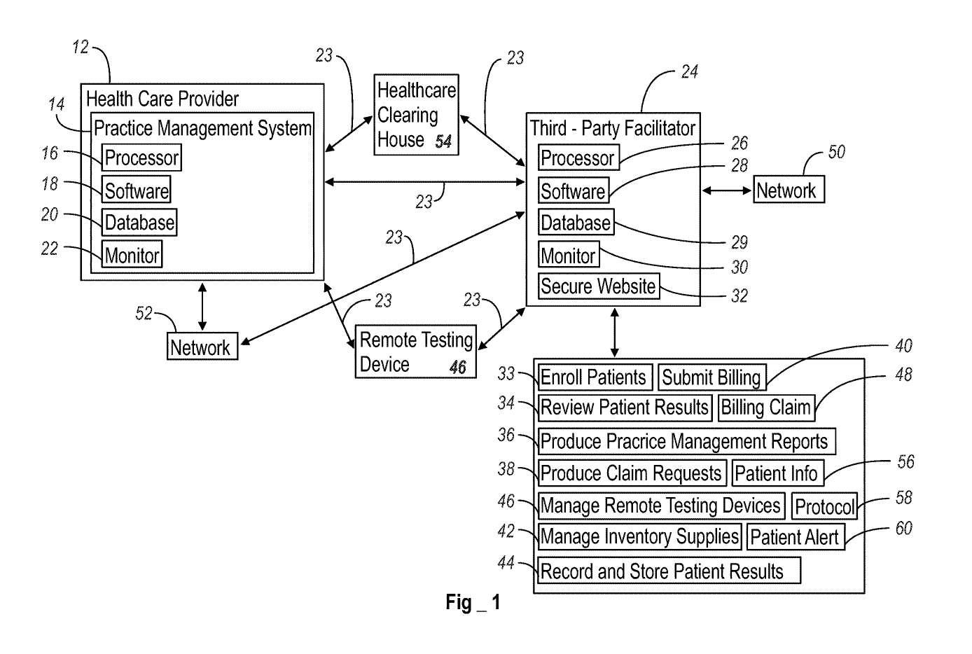

FIG. 2 is a flow diagram of a method of healthcare monitoring and billing system;

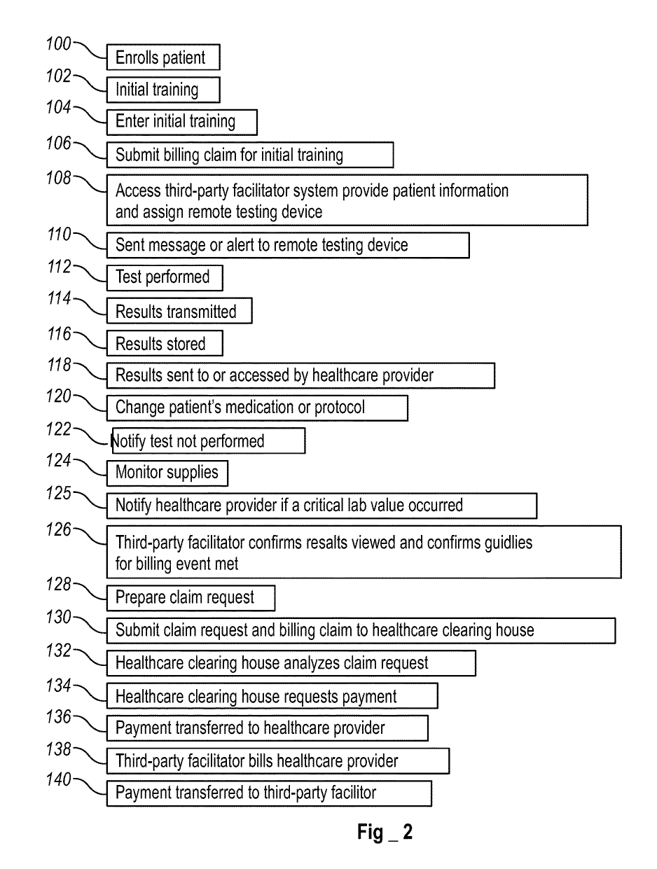

FIG. 3 is a plan view of an account setup form for the remote healthcare monitoring and billing system;

FIG. 4 is plan view of a leads by account page of the remote healthcare monitoring and billing system;

FIG. 5 is a plan view of a leads page of the remote health care monitoring and billing system;

FIG. 6 is a perspective view of a testing device, consumable supplies used in the testing device and a computing device or handheld device (in the form of a smart cell phone) that includes an application used to transmit test readings to the remote health care monitoring and billing system;

FIG. 7 is a plan view of a patient profile page of the remote health care monitoring and billing system, the profile page including a chart of test readings;

FIG. 8 is a plan view of a delinquent patients report page of the remote health care monitoring and billing system;

FIG. 9 is a plan view of a billing report management page 374, the view showing available reports that have not yet been billed of the remote health care monitoring and billing system;

FIG. 10 is a plan view of a billing report management page 374, the view showing billing report history of the remote health care monitoring and billing system;

FIG. 11 is a plan view of a supply order page of the remote health care monitoring and billing system.

### DETAILED DESCRIPTION OF THE PREFERRED EMBODIMENTS

Referring to the Figures, a remote healthcare monitoring and billing system 10 includes a healthcare provider 12 that involves physicians, nurses, and other healthcare personnel in the diagnosis and treatment of healthcare issues and a third party facilitator 24. The healthcare provider 12 has a practice management system 14 that includes a processor 16 for operating software 18, storing data in a database 20, and displaying information on a monitor 22 or the like.

The practice management system 14 is connected via an electronic network 23, such as the Internet, with a third-party facilitator system 24 that similarly includes a processor 26 for operating facilitator software 28, a database 29 for storing information and displaying information on a monitor 30 and/or a secure website 32.

The third-party facilitator system 24 enables the healthcare provider 12 to enroll patients 33, review and monitor patient results 34, as well as produce patient management reports 36, produce claim requests 38, submit billing 40 to the healthcare provider 12 or on behalf of healthcare provider 12, and manage remote testing devices 46, manage inventory supplies 42 and record and store patient results 44.

The third-party facilitator system 24 is connected via the electronic network 23 with remote testing device 46. A billing claim 48 is either billed through a network 50 of third-party facilitator 24, or billed through a network 52 of the healthcare provider 12 using the data collected through the third-party facilitator 24. The billing claim 48 is paid by a healthcare clearing house 54 through established processes.

In operation, at step 100, the healthcare provider 12 enrolls a patient 33 in the system 10. At step 102, the healthcare provider 12 performs initial office training with the patient 33 with respect to the operation of the remote testing device 46. At step 104, information related to the initial training is entered into the practice management system 14 and the third party facilitator system 24 to automatically trigger a billing claim 48 for the initial training is submitted to a healthcare clearing house 54 for payment at step 106, assuming the training is a billable event.

At step 108, the healthcare provider 12 also accesses the third party facilitator system 24 via the electronic network 23 and enrolls the patient 33 by providing patient information 56 and assigning a remote testing device 46 to the patient 33. Included in the patient information 56 is a protocol 58 that outlines when remote tests are to be conducted.

At step 110, the processor 26 of the third-party facilitator system 24 is capable of sending a message or alert 60 to the patient 33 or directly to the remote testing device 46 as a reminder to perform both a current and/or delinquent remote test. The message is sent to the patient's phone, electronic device and/or the remote testing device 46. Alternatively, the health care provider 12 can access the remote testing device 46 either through third-party facilitator system 24, or directly, and vice versa, that is the remote testing device 46 can provide results or feedback to either or both the third-party facilitator system 24 and/or the health care provider 12, directly or through the other. Alternatively, the message or alert 60 is sent directly to the remote testing device 46. At step 112 a test is performed.

When a test is performed, at step 114, the results 34 are automatically transmitted from the remote testing device 46 to the facilitator system 24 through electronic network 23. At step 116, the results 34 are stored by processor 26 in database 29. At step 118, the results 34 may be automatically sent by the processor 26 to the healthcare provider 12 or may be accessed by the healthcare provider 12 on the secure website 32 of the facilitator. At step 120, based upon review of the results 34, the healthcare provider 12 may change a patient's medication and/or protocol. At step 122, the processor 26 also can notify the healthcare provider 12 if a remote test has not occurred. At step 124, the processor 26 also monitors the supplies 42 used for the remote test and will inform the healthcare provider 12 when additional supplies 42 are needed. At step 125, the processor 26 can notify the healthcare provider 12 if a critical lab value occurred.

At step 126, the third-party facilitator 24 confirms that the results 34 have been reviewed by the healthcare provider 12, and further confirms guidelines have been met for a billing event 62. At step 128, the processor 26 of the third-party facilitator 24 automatically prepares a claim request 38. At step 130, the third-party facilitator 24 submits a claim request 38 and billing claim 48 to healthcare clearing house 54, either directly or through automated reporting to healthcare provider 12. Upon receipt of the claim request 38, healthcare clearing house 54 analyzes the claim request 38 to determine whether it meets the necessary requirement for payment at step 132.

In the event the claim request 38 is verified, at step 132, healthcare clearing house 54 processes the claim request 38 and requests payment of billing claim 48 from healthcare provider 12 at step 134. At step 136, payment is transferred from the insurance company, Medicare, or other payer to the healthcare provider 12 after claim has cleared. At step 138, third-party facilitator 24 bills the healthcare provider 12 for the facilitation of the provider driven model Services under a predetermined contract. At step 140, payment is transferred for these services to third-party facilitator 24.

During this process, the healthcare provider 12 will also have access to various patient and device management reports 44 through the third-party facilitator's secure website 32. These reports will be highly customizable based on the need of the healthcare provider.

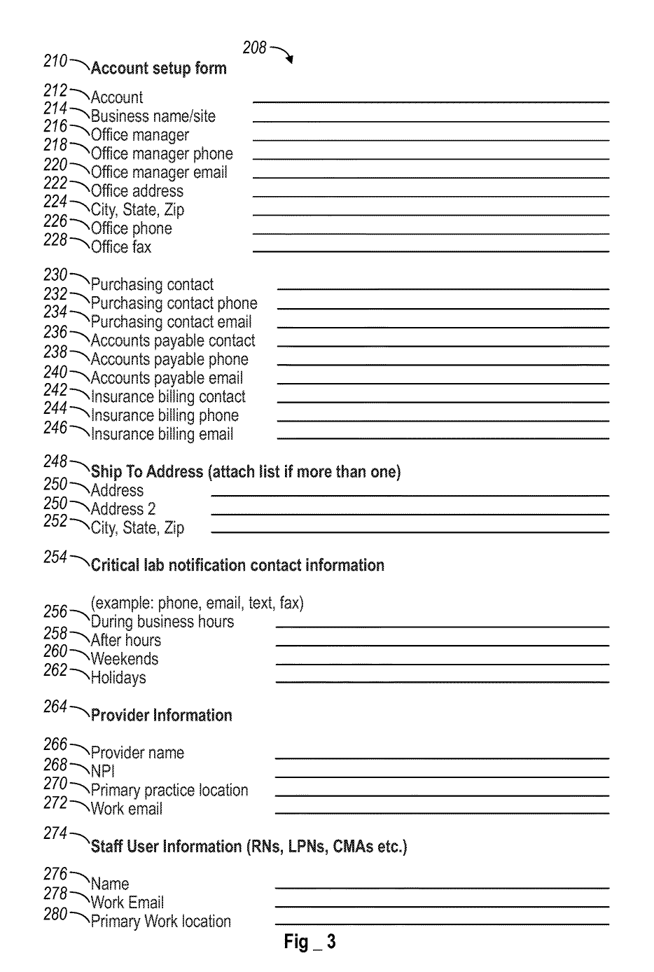

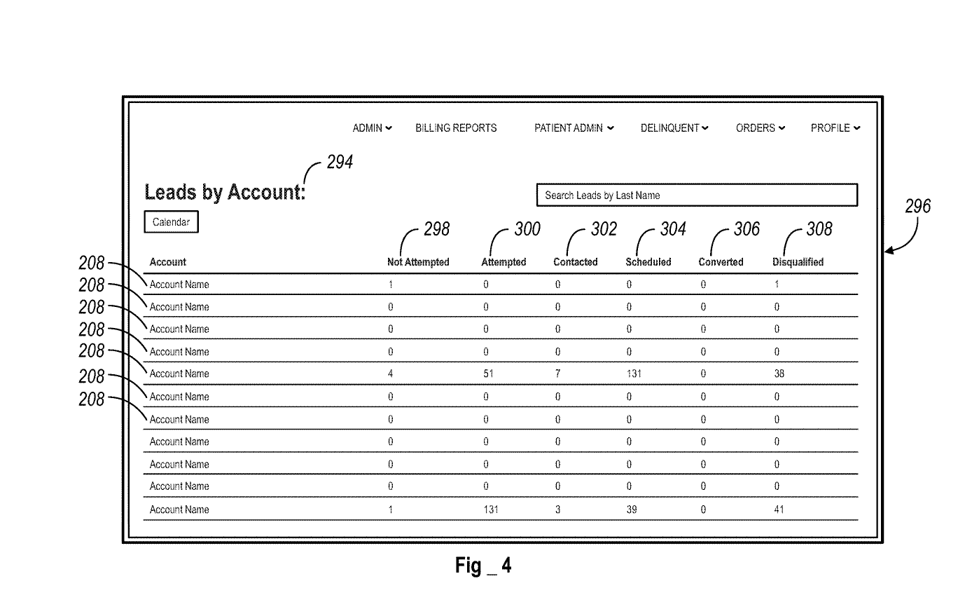

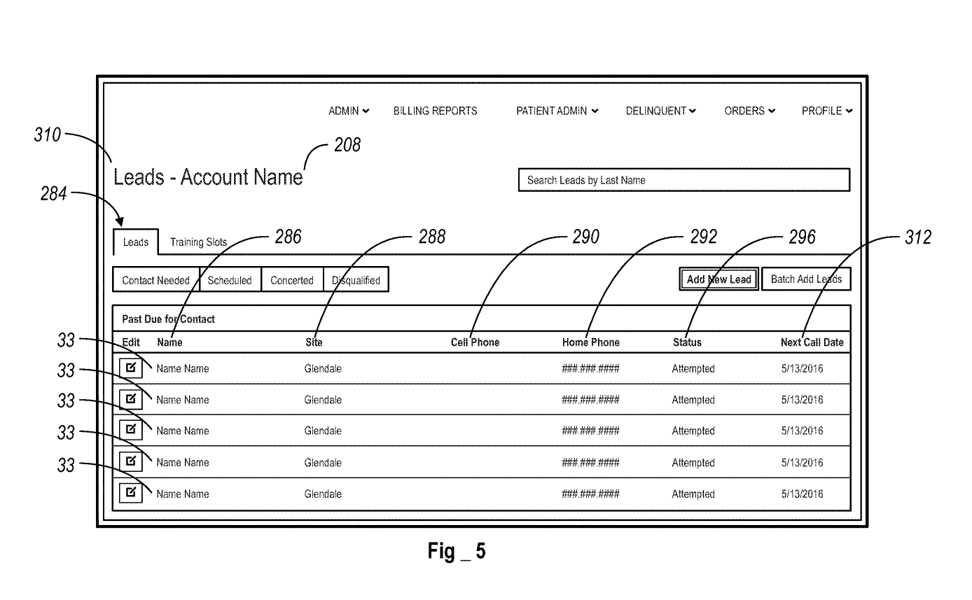

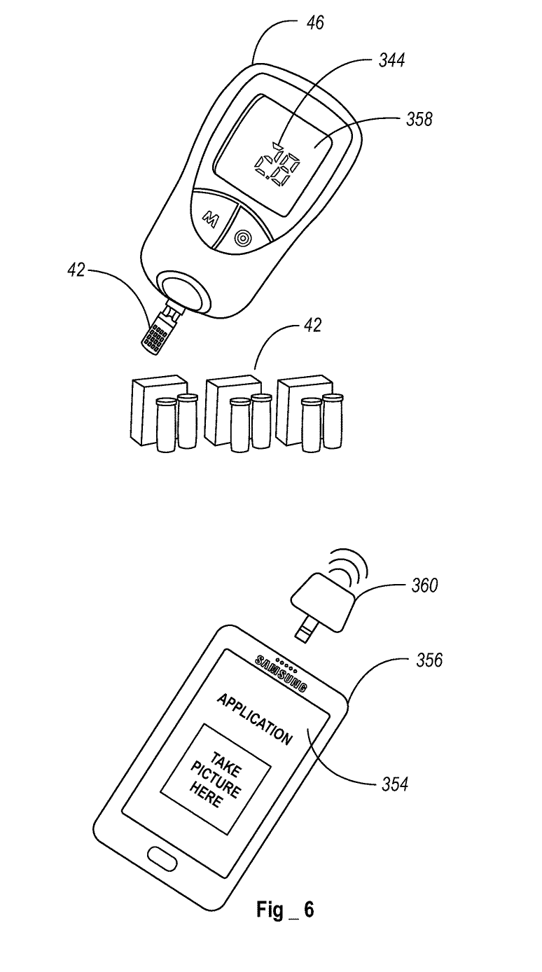

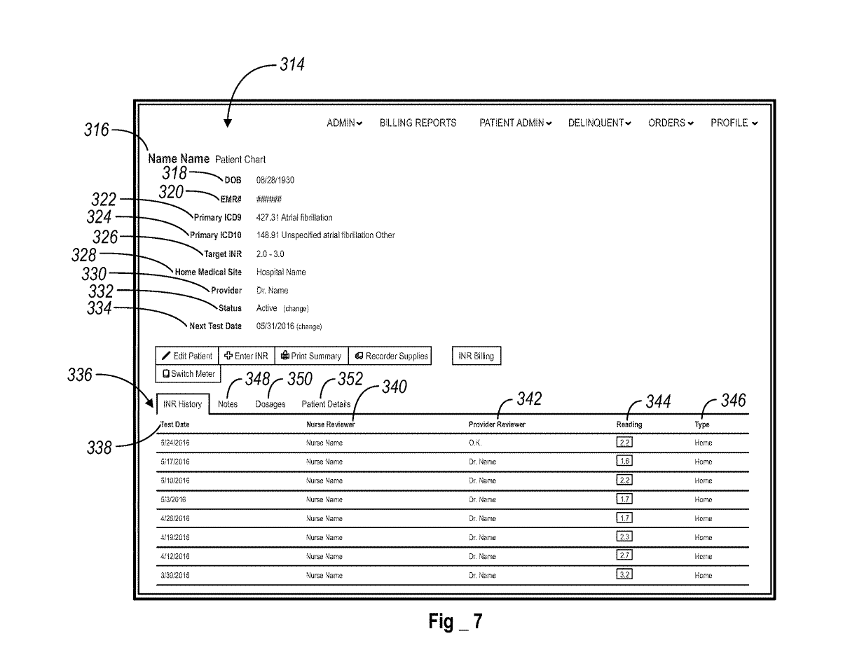

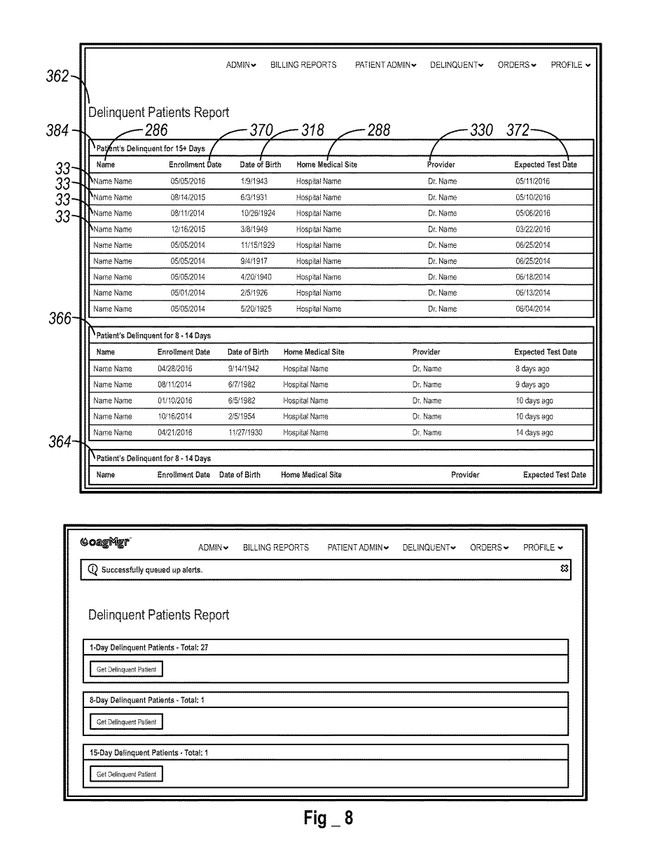

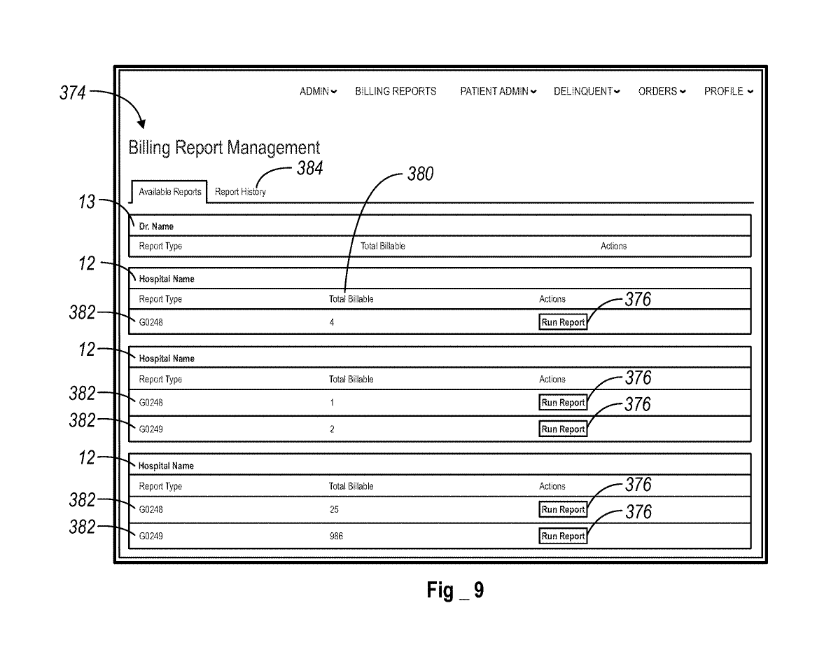

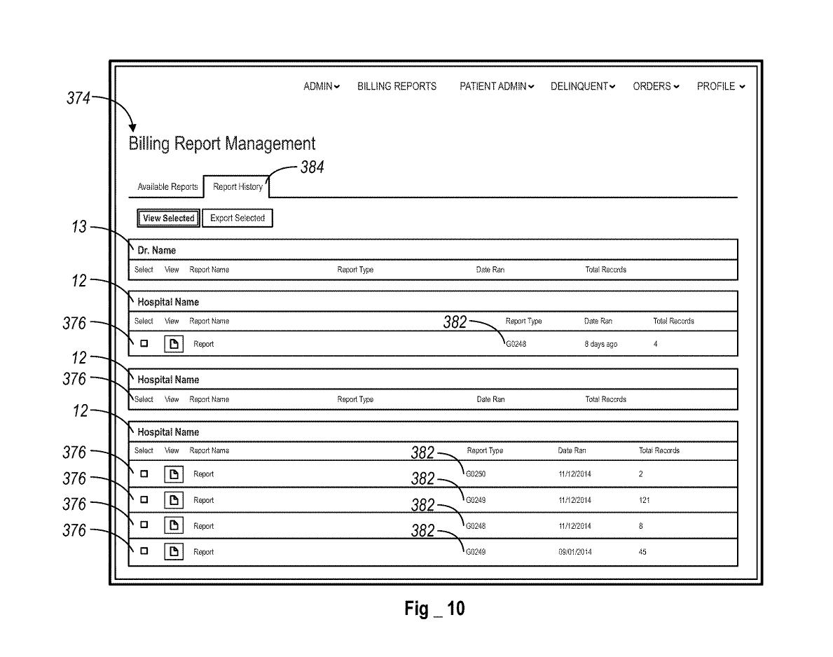

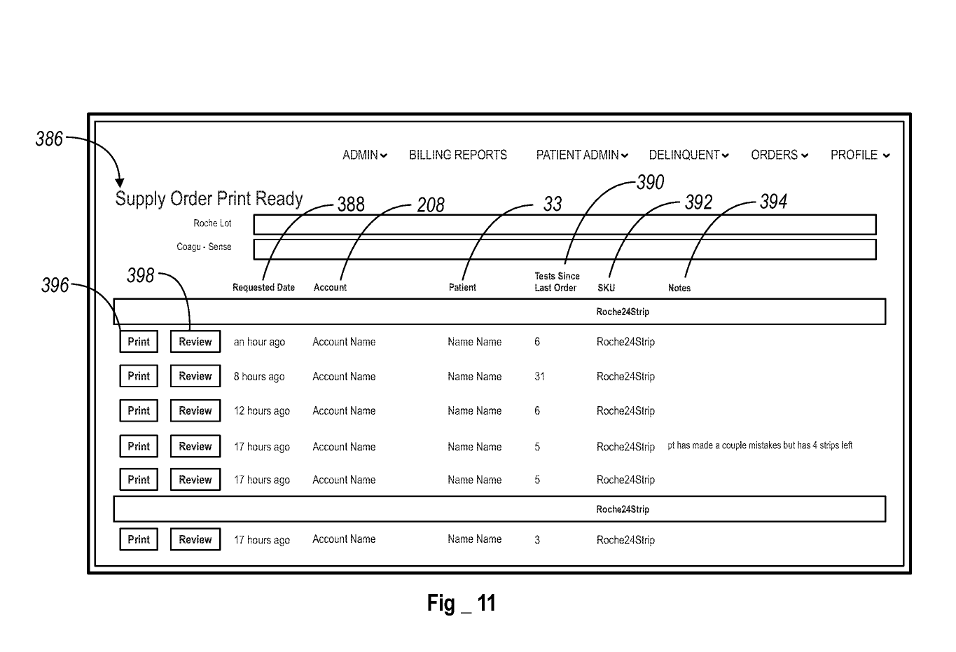

As one example, with reference to FIGS. 3-11 the remote healthcare monitoring and billing system 10 (system 10) presented herein is used to monitor patients 33 that are on Coumadin as one of countless forms of a prescription 200 the requires monitoring. Coumadin, also generically known as Warfarin, is a blood thinner available by prescription only. Patients 33 can be on Coumadin for any period of time. Coumadin is often prescribed to patients 33 post-surgery for a short period of time to help the healing process, prevent blood clots as well as for other reasons. Due to the short period of time that these patients 33 are on Coumadin, these patients 33 and their prescription 200 are easily managed using conventional techniques by health care provider 12 (such as a nurse, physician's assistant, physician, doctor's office, clinic or the like).

For other patients 33 suffering from long-term chronic diseases or conditions, such as mechanical heart valve patients, patients with Atrial Fibrillation (AFib), patients with clotting disorders, patients particularly susceptible to deep-vein-thrombosis (DVT), pulmonary embolism patients and the like, Coumadin is often prescribed on a long-term basis for the long-term management of these chronic diseases and conditions. Due to the long-term nature of the Coumadin prescription 200 for these patients 33, these patients 33 provide unique management challenges for the health care provider 12. The remote health care monitoring and billing system 10 presented herein is particularly well suited to help the health care provider 12 manage these chronic disease or condition patients 33 on a long-term prescription of Coumadin (Warfarin), which serve as the basis of this example.

Patients 33 on a long-term prescription 200 of Coumadin need to manage their International Normalized Ratio (INR). INR is a lab test result that basically measures the thickness/thinness of the patient's blood. Conventionally, patients 33 on Coumadin are required to go into the office of the prescribing health care provider 12 (such as their doctor's office, a clinic or the like) or a lab that the doctor or health care provider 12 refers the patient to, every 4-6 weeks to have the thickness of their blood tested. If the patient's INR is tested to be in range, generally the patient 33 would continue on their same prescription 200 (e.g. dosage of Coumadin) and regiment. If the patient's INR is tested to be out of range, corrective actions are immediately taken. This may include re-testing the patient 33, changing the patient's prescription 200, performing further tests, suggesting dietary changes, among many other possible corrective actions.

One reason health care providers 12 only test a patient's INR every 4-6 weeks is because performing the INR test is extremely inconvenient for both the patient 33 as well as the health care provider 12. That is, conventionally, to test the patient's INR the patient 33 must travel to the office of the health care provider 12, they must then check-in, wait in line for a nurse, physician's assistant or doctor, and then the test is performed. Once performed, the results of the test must be recorded into the patient's file and the information must be transmitted to the appropriate nurse, physician's assistant and/or doctor for review.

This conventional testing process is inconvenient for the patient 33 because the patient must set aside everything in their life and travel to the office of the health care provider 12 for the test. This may be particularly difficult because many patients 33 on long-term Coumadin prescriptions are elderly and/or have chronic conditions that make it difficult for them to travel. The time and travel associated with this conventional testing process increases the cost of the testing to the patient 33.

This conventional testing process is inconvenient and expensive for the health care provider 12 because they must provide a facility to perform the test as well as provide the personnel that can schedule the testing, manage the intake of the patient 33, perform the test, discharge the patient 33, record the patient results 34/44, and transmit the information to the needed parties (such as the treating physician 204, the treating physician's support staff 206 such as a physician's assistant or nurse). Due to these inefficiencies and inconveniences, performing INR testing is often a low-revenue endeavor or even a loss-center in many instances for health care providers 12. Due to these inefficiencies and inconveniences, conventionally testing INR is performed less frequently than is optimal.

That is, when a patient's INR is only tested once every 4-6 weeks there is a high probability that the patient's INR may drift out of the desired range (also known as the therapeutic range). When the patient's INR is out of therapeutic range the patient 33 is at increased risk of a stroke, internal bleeding, hemorrhaging, and hospital visits, even death if the patient's their blood is too thick or thin. The farther the INR is outside of the therapeutic range, the higher the risk. The longer the INR is outside of the therapeutic range, the higher the risk of adverse events. The longer the period of time between testing intervals, the longer the patient is likely to spend outside of the therapeutic range and the farther the patient is likely to be outside of the therapeutic range. As such, infrequent INR testing is likely to lead to more frequent adverse events and more the more serious those adverse effects are likely to be.

Many studies have proven the effectiveness and desirability of weekly INR testing. Weekly INR testing increases the amount of time the patient 33 is in the therapeutic range (and reduces the amount of time the patient 33 spends outside of the therapeutic range). Closely maintaining the patient's INR within the therapeutic range has an overall reduction on the cost of providing healthcare to Coumadin patients, by lowering their risk for adverse events.

In 2008, Medicare approved new billing codes to allow for reimbursement for home testing of INR. The 3 billing codes are:
G0248-1-time training code. This billing code provides reimbursement for health care provider 12 to provide training a patient 33 how to use an in-home testing device (remote testing device 46) and perform in-home INR testing.
G0249—Monthly reimbursement of in-home testing equipment (remote testing device 46) and supplies 42. This billing code provides reimbursement for in-home INR testing equipment (remote testing device 46) and in-home testing supplies 42 consumed during in-home INR testing. This billing code provides for reimbursement for in-home testing that occurs not more frequently than once per week.
G0250—Monthly physician review fee. This billing code provides reimbursement for a physician (health care provider 12) to review in-home INR testing results.

Even though these billing codes have been around since 2008, there is only a small percentage of the Coumadin population on in-home testing programs. This is because of the complexities and inefficiencies associated with facilitating and performing in-home INR testing.

Most home testing programs are designed by Independent Diagnostic Testing Facilities (IDTF's). IDTFs act as a referral from the treating physician 204 and/or the health care provider 12. If the treating physician 204 and/or health care provider 12 has a patient 33 that would be suitable for in-home testing, the treating physician 204 and/or health care provider 12 refers the patient 33 to the IDTF. The IDTF then trains the patient 33, and provides the testing equipment (remote testing device 46) and supplies 42. In return, the IDTF has established contracts with Medicare, Medicaid and other third party payers (the insurance companies) collectively “third party payers” 202. Therefore, the IDTF would bill the G0249 billing code, and that is their revenue source.

However, the IDTF model is flawed, which is why only a small percentage of the Coumadin population participates in in-home testing. Even though providing in-clinic INR tests every 4-6 weeks is a low revenue model for the treating physician 204 and/or health care provider 12 (and in most cases it is actually a cost center), the treating physician 204 and/or health care provider 12 would rather keep performing the INR testing rather than refer the patient 33 to an IDTF, for several reasons:
First: If the treating physician 204 and/or health care provider 12 refers the patient 33 to an IDTF, the treating physician 204 and/or health care provider 12 loses transparency into their patient's INR history and control of the patient 33. That is, the p treating physician 204 and/or health care provider 12 no longer is able to see the ebbs and flows of the patient's INR tests. Since the treating physician 204 and/or health care provider 12 is still treating the patient 33 for their underlying medical condition, it makes sense that the treating physician 204 and/or health care provider 12 typically wants to manage their INR through their prescription 200 for Coumadin as well.
Second: The treating physician 204 and/or health care provider 12 has no incentive (other than reducing a cost center) to refer their patients 33 to an IDTF.

For these reasons, very few treating physician 204 and/or health care provider 12 use IDTFs and instead the physicians and the patient's 33 suffer through using an inefficient system of INR testing that leads to far too infrequent testing and sub-optimal INR control.

In contrast, by applying the remote health care monitoring and billing system 10 presented herein, the system 10 achieves the following results and benefits:
Reduces the staffing burden of the treating physician 204 and/or health care provider 12, as less patients 33 are coming for a low-level and high-cost visit.
Provides an avenue for the patient 33 to test weekly instead of every 4-6 weeks, therefore improving the overall health care of the patient 33.
Provides a financial incentive for the treating physician 204 and/or health care provider 12, through the use of the three 3 G-Codes (G0248, G0249, G0250) explained above.
Improves patient satisfaction, as it reduces the burden on the patient 33 for such frequent visits to their treating physician 204 and/or health care provider 12.
   How the Remote Health Care Monitoring and Billing System 10 Works in this Example:

The treating physician 204 and/or health care provider 12 enroll in the remote health care monitoring and billing system 10 by entering into a Business Associates' agreement (BAA) with the third party facilitator 24 that has established and manages the remote health care monitoring and billing system 10.

Next, the third party facilitator 24 sets up an account 208 for the treating physician 204 and/or health care provider 12. This account 208 includes all of the relevant and necessary information for third party facilitator 24 to facilitate the account 208 and manage the system 10. This information may include, but is not limited to the information shown on the account setup form 210:
Account name or number 212
Business name/site 214
Office manager name 216
Office manager phone number 218
Office manager email address 220
Office street address 222
Office city, state, zip code 224
Office phone 226
Office fax 228
Purchasing contact name 230
Purchasing contact phone number 232
Purchasing contact email address 234
Accounts payable contact name 236
Accounts payable contact phone 238
Accounts payable contact email address 240
Insurance billing contact name 242
Insurance billing phone number 244
Insurance billing email address 246
Ship to address 248
   Ship to street address 250
   Ship to city, state and zip 252
Critical lab notification contact information 254
   During business hours 256
   After hours 258
   Weekends 260
   Holidays 262
Provider information 264
   Provider name 266
   NPI (National Provider Information) 268
   Primary practice location 270
   Work email 272
Staff user information 274
   Name 276
   Work email 278
   Primary work location 280

This and any other information is obtained and recorded in the third party facilitator's database 29 and is used to administer the system 10.

Next, the third party facilitator 24 trains the treating physician(s) 204 and/or health care provider 12 and their staff 282 on how to use the testing device 46 and how to use the remote health care monitoring and billing system 10. This is administered by on-site training as well as any other training method such as through workbooks, tests, quizzes, webinars and the like.

Next, a list 284 of potential patients 33 that could benefit from enrolment in the system 10 is developed by the treating physicians 204 and/or health care provider 12. This list 284 includes potential patients 33 that have conditions that require monitoring and that would potentially fit the requirements of the system 10. This list 284 is provided to the third party facilitator 24. This list 284 includes the necessary information to contact the potential patients 33 including, but not limited to the following information:
Patient name 286
Site 288 which is the location of the patient's health care provider
Cell phone number 290
Home phone number 292

Next, the list 284 of potential patients 33 that may benefit from enrolment in the system 10 is imported into the database 29 of the system 10 by third party facilitator 24. The system 10 of third party facilitator 24 includes a leads by account page 294 that organizes all of the potential patients 33 for each account 208. This leads by account page 294 aggregates all potential patients 33 for each account 208 and includes the aggregate status 296 of the potential patients 33 for each account 208. The status 296 includes the following categories: not attempted 298, attempted 300, contacted 302, scheduled 304, converted 306, and disqualified 308. The leads by account page 294 helps the third party facilitator 24 track potential patients 33 for each account 208 and helps the third party facilitator 24 to quickly manage the process of reaching out to these potential patients 33 and attempting to enroll them in the system 10.

When any account 208 is clicked on, the leads page 310 is presented. The leads page 310 lists the potential patients 33 for each account 208 including their name 286, site 288, cell phone number 290, home phone number 292, status 296 and any other pertinent information about the potential patient 33. The leads page 310 also includes the next call date 312 which is generated by the system 10 or entered by the third party facilitator 24. This leads page 310 allows for the addition of new leads. This leads page 310 allows for the efficient administration of contacting potential patients 33 by the third party facilitator 24.

The third party facilitator 24 generates revenue utilizing the following model:
The third party facilitator 24 generates one-time revenue for sale of the testing device 46 to the health care provider 12 which is then provided to the patient 33, or alternatively the sale is made directly to the patient 33 by the third party facilitator 24. While the term “sale” is used herein, this may include an outright sale, a sale using installment payments, a sale using credit terms, a lease, a renting scheme, a lease to own scheme or any other financial model. In this example where a patient's INR is being tested, the testing device 46 may be a Coaguchek INR testing device manufactured by Roche Diagnostics having an address of 9115 Hague Road, Indianapolis, Ind. 46250-0457. Any other similar at-home INR testing device can be used as part of the system 10. The cost of this, can wholly or at least partially be absorbed by the G0248—1-time training code, alternatively the cost of this can be absorbed over time through the G0249—monthly reimbursement for in-home testing equipment.
The third party facilitator 24 also generates recurring revenue for the replenishment of consumable supplies 42 required for testing. The system 10 tracks the patient's supply of consumable supplies 42. In one arrangement, the system 10 orders the consumable supplies 42 directly for the patient. In another arrangement, the system 10 informs the patient 33 of the need to reorder the consumable supplies 42 through a phone call, email, text message or any other way. In one arrangement, consumable supplies 42 are resupplied when the patient 32 has only two test strips remaining. The cost of resupplying the consumable supplies 42 can be absorbed through the G0249—monthly reimbursement for in-home testing equipment and reimbursement for testing supplies 42.
The third party facilitator 24 generates recurring revenue for the administration of the system 10. This includes the management of patients 33, the transfer of information from the patient 33 to the health care provider 12, treating physician 204 and/or the treating physician's support staff 206 as well as all the other duties, tasks and maintenance related to establishing and maintain the system 10. The cost of this can be absorbed partially through the G0249—monthly reimbursement for in-home testing equipment.

When a the third party facilitator 24 reaches out to a potential patient 33 and the patient 33 meets the requirements to be enrolled in the system 10 and the patient 33 agrees to be enrolled in the system 10, the third party facilitator 24 schedules an initial training with the patient 33. Generally this initial training meeting occurs at the treating physician's office, or the health care provider's office, however this meeting can occur anywhere such as at the patient's home or any other place. At the meeting, administrators, such as nurses, of the third party facilitator 24 train the patient 33 how to use the testing device 46, how to use the consumable supplies 42, how to use report their test results 34/44, how to contact the third party facilitator 24 in the event of questions or the need for assistance, how to order supplies 42, how to reach the customer service department of the third party facilitator 24 as well as provide them with any other learning and teaching needed. In addition, at this meeting, the third party facilitator 24 supplies the patient with the testing device 46 and their first installment of supplies 42.

The third party facilitator 24 also enrolls the patient 33 in the system 10 by establishing a patient profile 314. The patient profile 314 includes all of the pertinent information needed to manage the prescription 200 for patient 33 and track the patient's condition. As one example, the patient profile 314 includes the patient's name 316, the patient's date of birth (DOB) 318, the patient's electronic medical record number (EMR#) 320, the patient's primary International Statistical Classification of Diseases and Related Health Problems 9 code (ICD9) 322, the patient's primary International Statistical Classification of Diseases and Related Health Problems 10 code (ICD10) 324, the patient's target INR 326 (which is typically a range of values that establish the therapeutic range for the patient), the patient's home medical site 328, the patient's health care provider 330, the patient's status 332 and the patient's next test date 334, among any other information.

The patient's profile 314 also includes the patient's test history chart 336. The patient's test history 336 can take on any form of a table or chart that provides the patient's history of test readings such as a table, chart, line graphs, bar graphs or the like. In the example shown, the patient's test history 336 is formed of a chart in chronological order including the test date 338, the reviewing nurse 340, the reviewing provider 342 (which is typically the treating physician 204) the test reading 344 and the type of reading 346 (whether it is at home, in-office, or otherwise). In one arrangement, the test reading 344 is color coded to quickly identify to the reviewing nurse 340 and/or the reviewing provider 342 whether the reading is in the therapeutic range or outside of the therapeutic range, and if it is outside of the therapeutic range how far it is outside of the therapeutic range.

The patient's profile 314 also includes a notes page 348 that provides a place to retain notes related to the patient 33 and their prescription 200 and treatment, a dosages page 350 that provides a place to retain information related to the patient's dosage, and a patient's details page 352 that provides a place to record additional details related to the patient 33. Any other information or rubric for storage and presentation of information related to patient 33 may be included in the patient's profile page 314.

Once the patient 33 goes through the required training and displays an understanding and proficiency in using the testing device 46 and system 10, the patient 33 begins performing in-home testing using the supplied testing device 46 and consumable supplies 42.

When a test is performed, the patient 33 reports their test results using by any manner, method or means. In one arrangement, the patient 33 may select from the following options to report the results:
The patient 33 may use an automated phone system, or interactive voice response (IVR) system established and managed by the third party facilitator 24. In doing so, the patient 33 provides their account information, including any of or any combination of: their name, a password, an account number, a personal identification number or the like. Once they have accessed their account, the patient 33 provides their test result. The test result is then recorded into the test reading 344 of the patient's test history 336.
The patient 33 may call the customer service department of the third party facilitator 24. The patient 33 may speak directly with a customer service representative of the third party facilitator 24 and provide their account information (as is described above) or they may provide this information on a voice recording. Whether speaking with a customer service representative directly or on a recording, the patient 33 provides their test result. The test result is then recorded by a customer service representative of third party facilitator into the test reading 344 of the patient's test history 336.
The patient 33 may log onto the website 32 of the third party facilitator 24 through electronic network 23. In doing so, the patient 33 may access their account using account information (as is described above). Once the patient 33 accesses their account, the patient 33 enters their test reading 344 which is recorded into the patient's test history 336.
The patient 33 may use an application 354 installed on a computer, cell phone, tablet or other computing device or handheld device 356 to report their test reading 344. In one arrangement, the application 354 and/or the computing device or hand held device 356 is linked to the patient 33 and the patient's profile 314, through the use of information from the application 354 and/or computing device or hand held device 356 (such as a cell phone number, ISP number, a stored password, stored account information or the like) such that when the application 354 connects with the third party facilitator 24 over electronic network 23 the reported information is recorded directly in the patient's profile 314. In another arrangement, when the application 354 is opened and the application 354 connects with the third party facilitator 24 over electronic network 23, the patient 33 must enter account information (as is described above) before a test reading 344 is transmitted, the system 10 automatically records the test reading 344 in the
   As one example, the patient 33 opens the application 354 and the patient 33 enters their test reading 344 into the application 354 and transmits it to third party facilitator. This process is simple, fast and effective. However, this process does allow for the patient to enter their test reading 344 incorrectly.
   As another example, the patient 33 opens the application 354 and the patient 33 takes a picture of the display 358 of the testing device 46. The application processes the image and reports the test reading 344 to the third party facilitator 24. This process is simple, fast and effective. While this process removes the possibility that the patient 33 may enter the test reading 344 incorrectly, this process allows for the test reading 344 to be improperly interpreted by the application 354.
   As another example, an infrared device or other wireless communication device 360 is connected to the computing device or handheld device 356, such as through an ear phone jack thereby enabling communication between the computing device or handheld device 356 and the testing device 46. Using this process, the patient 33 installs the wireless communication device 360 onto the computing device or handheld device 356, such as by inserting the wireless communication device 360 into the ear phone jack, and the patient 33 opens the application 354. Once opened the patient activates the testing device 46 and/or the application 354 to transmit the test reading 344. Once the test reading 344 is transmitted to the computing device or handheld device 356, the computing device or handheld device 356 transmits the test reading 344 to the third party facilitator 24 over electronic network 23.

The above are merely examples, and the test reading 344 may be transmitted from the patient 33 to the third party facilitator 24 by any other manner, method or means.

Once the test reading 344 is transmitted to the third party facilitator 24, if the test reading 344 is out of range, the system 10 flags the reading and an alert is transmitted to the health care provider 12. In response to this out of range test reading 344, the health care provider 12 (such as the treating physician 204, the treating physician's support staff 206 such as a nurse or physician's assistant or the like) will call the patient 33 or contact the patient 33 by any other manner or means such as by text, email or the like. If on the other hand the test reading 344 is in range (within the therapeutic range) the patient 33 is trained to understand that they will not be contacted by their health care provider 12.

During use of the system 10, the health care providers 12 use the system 10 as a stand-alone electronic health record (EHR). Periodically, the health care provider 12 (such as the treating physician 204 or the treating physician's support staff 206 such as a nurse or physician's assistant or the like) logs in to the system 10 and reviews the test readings 344 that have been reported from their patients 33. If the test result 344 is in range, the health care provider 12 marks the test reading 344 as reviewed and no additional work needs to be done. If the test reading 344 is out of range, the health care provider 12 (such as the treating physician 204, the treating physician's support staff 206 such as a nurse or physician's assistant or the like) calls the patient 33 and follows the same protocol used if an out of range test reading 344 was obtained during an in-office visit, such as performing a re-test, adjusting the patient's dosage, performing additional tests, recommending diet changes, or the like.

Each health care provider 12 (such as a treating physician 204) defines what they consider a “critical” test reading 344. A critical test reading 344 means, not only is the test reading 344 lab out of range, but the test reading 344 is dangerously out of range. When this happens, the third party facilitator's 24 customer service is notified in real time, and and the third party facilitator 24 communicates the existence of this critical test reading 344 to the health care provider 12 immediately. It is likely then that the health care provider 12 (such as the treating physician 204, the treating physician's support staff 206 such as a nurse or physician's assistant or the like) immediately calls the patient 33 and follows the same protocol used if a critically out of range test reading 344 was obtained during an in-office visit, such as performing a re-test, adjusting the patient's dosage, performing additional tests, recommending diet changes, or the like.

The system 10 manages patients 33 who are delinquent in reporting a test result 344. If a patient 33 is delinquent in performing a test, meaning they are past due to report a test, reading 344, automated reminders are transmitted to the patient 33 reminding them of the requirement to report a test reading 344 to the third party facilitator 24. These automated reminders may be transmitted on any frequency, such as daily, hourly, weekly, or the like. These reminders may take the form of a text message, phone call, email, or the like. To manage these delinquent patients 33, the system 10 generates a delinquent patient report 362.

The delinquent patient report 362 breaks the delinquent patients 33 into three categories:
Patients Delinquent for 2-7 days 364.
Patients delinquent for 8-14 days 366.
Patients delinquent for 15+ days 368.

These delinquent patient reports 362 links to the patient profile 314 and includes all of the patient information needed and manage the patient 33 including the patient's name 286, the patient's enrollment date 370, the patient's date of birth 318, the patient's home medical site 288, the patient's provider 330, and the expected test date 372, among any other needed or relevant information. The health care provider 12 determines the rules and guidelines as to how to address the patients 33 in each category of the delinquent patient report 362 such as phone calls, emails, text messages, in-person visits and the like.

An important aspect of the system 10 is to facilitate billing for the services provided by the health care provider 12. To facilitate appropriate billing, the system 10 includes a billing report management page 374. The system 10 provides billing reports 376 to the health care provider 12 to integrate the billing events into their practice management system 14, so that the revenue can be captured through their established billing practices. That is, the system 10 provides the health care provider 12 with verified billing reports 376 that can be easily integrated into the health care provider's established billing practices (such as through their practice management system 14) which are then paid by a third party payer such as Medicare, Medicaid, health insurance or the like. This enables the health care provider 12 to easily capture revenue that was previously difficult or impossible to capture. That is, the system 10 provides the billing reports 376 to the health care provider 12 and the health care provider 12 submits the billing events to third party payers such as Medicare, Medicaid, health insurance or the like.

The billing report management page 374 includes the health care provider 12, the report type 378, the total billable events 380 and links to the billing reports 376. The billing reports 376 on the billing report management page 374 are broken down by billing code 382. The billing report management page 374 also includes a tab for billing report history 384 which includes prior billing reports 376,

The reviewing provider 342 (which is typically the treating physician 204 or another physician) is required to periodically log-on to the system 10 and review the test readings 344 that have previously been reviewed by the reviewing nurse 340. In doing so, the reviewing provider 342 (treating physician 204) has the opportunity to review all activity, review patient charts, etc. This periodic review by the reviewing provider 342 (treating physician 204) is necessary to trigger the G0250 billing code 382.

When using the system 10, the system 10 tracks the patient's supply of testing supplies 42. Patients 33 are instructed to order replacement testing supplies 42 when needed. In one arrangement, when used for INR testing, patients 33 are instructed to reorder testing supplies 42 when they have 2 test strips remaining. The patient 33 may be instructed to reorder testing supplies 42 by an email, text message, phone call or by any other message or information transmitted by the third party facilitator 24 to the patient 33. There are multiple ways testing supplies 42 can be ordered using the system 10:
The patient 33 may order testing supplies 42 by using the automated phone system, or interactive voice response (IVR) system established and managed by the third party facilitator 24.
The patient 33 may call the customer service department of the third party facilitator 24 and order the testing supplies 42 by speaking directly with a customer service representative of the third party facilitator 24 or by leaving a voice recording.
The patient 33 may order testing supplies 42 using the application 354 installed on a computer, cell phone, tablet or other computing device or handheld device 356 in the similar manner to how the application 354 is used to report the patient's test reading 344.

In one arrangement, to facilitate tracking of patient testing supplies 42 and billing for the resupply of testing supplies 42, system 10 includes a supply order page 386. Supply order page 386 includes the request date 388, the account 208, the patient 33, the tests since last order 390, the stock keeping unit number (SKU) 392 for the testing supplies 42 that are reordered and a notes 394 section for keeping notes on the patient 33 and their reorder history. This supply order page 386 also includes buttons to print 396 the reorder request or billing event, and review 398 the reorder request or billing event.

The system 10 also provides accessible charts, graphs, dashboards, and the like, that the practice management system 14 can access, to see the successes of the system 10.

The system 10 is capable of being integrated into electronic health records.

In one arrangement, the billing algorithm of the system 10 operates in the following manner:

For the G0249 Billing Code 382:
The system 10 runs billing codes once a day. The system 10 scans all test readings 344 that have been reviewed by a reviewing nurse 340, but are not associated with a billing event 380 and are not marked as “Billing Skipped” which indicates that the test reading 344 should not be included in a billing event 380. The system 10 orders the test readings 344 by test date 388. Because the G0249 billing code 382 allows for reimbursement of every four tests, not performed more than weekly, if four tests are each within distinct weeks (Sunday-Saturday), the system creates a billing event 380 for those four test readings 344 and associates the test readings 344 to the billing event 380. The system 10 takes the first test reading 344 within each week to be the official test reading 344 for that week for billing purposes. Subsequent tests within that week are marked as “Billing Skipped”. They're still valid medical tests, but they're not billable to Medicare/insurance.
The “Billed Date” for the billing event 380 event is 29 days after the first test date or the last test date, whichever is first chronologically.

For the G0250 Billing Code 382:
The system 10 generates a G0250 billing code 382 when all of the tests in a 249 have been reviewed by a reviewing provider 342.

From the above discussion it will be appreciated that the remote healthcare monitoring and billing system presented herein improves upon the state of the art.

Specifically, the remote health care monitoring and billing system is easier to use by healthcare providers and patients; offers more efficient enrollment, data transfer and tracking than prior art systems and methods; contains costs; automates billing; engages the patient and provider to strengthen accountability; and creates tracking of clinical and financial outcomes for a healthcare provider or healthcare system. among countless other advantages and improvements.

It will be appreciated by those skilled in the art that other various modifications could be made to the device without parting from the spirit and scope of this invention. All such modifications and changes fall within the scope of the claims and are intended to be covered thereby.

What is claimed is:

1. A method of tracking test results of patients comprising the steps of:
providing a remote heath care monitoring and billing system by a third party facilitator, the remote health care monitoring and billing system having a processor, software, a database and an interactive website accessible over an electronic network;
joining the remote health care monitoring and billing system by a health care provider;
providing an in-home testing device to a patient;
performing at least one in-home test using the in-home testing device by the patient;
reporting the results of the in-home test performed by the patient to the remote health care monitoring system over the electronic network;
reviewing the results of the in-home test by the health care provider over the electronic network;
generating at least one billing report to the health care provider by the remote health care monitoring and billing system after the patient performs the at least one in-home test and the health care provider reviews the results of the at least one in-home test.

2. The method of claim 1, wherein the test performed by the patient is an INR test.

3. The method of claim 1, wherein the third party facilitator provides training to the patient on how to perform tests using the in-home testing device.

4. The method of claim 1, wherein the health care provider incorporates the at least one billing report generated by the remote health care monitoring and billing system into a practice management system, wherein the health care provider transmits this billing report to a third party payer for payment.

5. The method of claim 4, wherein the third party payer is Medicare, Medicaid or an insurance company.

6. The method of claim 1, wherein the remote health care monitoring and billing system tracks when the patient is supposed to perform in-home tests.

7. The method of claim 1, wherein the remote health care monitoring and billing system reminds the patient when they are supposed to perform in-home tests.

8. The method of claim 1, wherein the remote health care monitoring and billing system tracks when testing supplies should be ordered.

9. The method of claim 1, wherein the remote health care monitoring and billing system tracks informs the health care provider when a critically out of range test result is received.
